(19) United States
(12) Patent Application Publication
(10) Pub. No.: US 2013/0084121 A1
(43) Pub. Date: Apr. 4, 2013

(54) PRINTER

(71) Applicant: Osamu Watanabe, Shizuoka-ken (JP)

(72) Inventor: Osamu Watanabe, Shizuoka-ken (JP)

(73) Assignee: TOSHIBA TEC KABUSHIKI KAISHA, Shinagawa-ku (JP)

(21) Appl. No.: 13/627,092

(22) Filed: Sep. 26, 2012

(30) Foreign Application Priority Data
Sep. 30, 2011 (JP) 2011-216992

(51) Int. Cl. B41J 13/00

(52) U.S. Cl. 400/642

(57) ABSTRACT

A printer comprises a storing section configured to store a label paper attached with a label on backing paper in a peelable way, a printing section prints on the label, a peeling platen roller configured to be rotated by driving force from a driving unit acting through a driving gear and be butted with the backing paper to convey the backing paper, a peeling unit configured to peel the label from the backing paper conveyed by the peeling platen roller, a first guide roller presses the backing paper from a surface opposite to a surface butted with the peeling platen roller and butts the backing paper with the peeling platen roller and a second guide roller presses the backing paper by butting with the backing paper from the surface opposite to the surface butted with the peeling platen roller between the peeling unit and the peeling platen roller.

### CROSS-REFERENCE TO RELATED APPLICATION

This application is based upon and claims the benefit of priority from Japanese Patent Application No. 2011-216992, filed Sep. 30, 2011, the entire contents of which are incorporated herein by reference.

### FIELD

Embodiments described herein relate to a printer.

### BACKGROUND

In the past, a label printer which prints information on the printing surface of a label paper wound into a roller shape and outputs the label on which the information is printed after peeling the label on which the information is printed from backing paper was known.

In such a label printer, by applying rotary force through a gear from a step motor as a power source, a platen roller conveying the label paper or a peeling platen roller peeling the backing paper from the label attached on the backing paper is driven. Afterwards, the conveyance of the label paper is carried out properly by adjusting the rotation moments of the platen roller and the peeling platen roller, and therefore, the printing also can be properly carried out on the label.

### BRIEF DESCRIPTION OF THE DRAWINGS

FIG. 1 is a solid diagram showing a printer to which an embodiment relates;

FIG. 2 is a solid diagram showing a state after an upper case of the printer shown in FIG. 1 is opened;

FIG. 3 is a solid diagram showing a state after a front cover of the printer in the state in FIG. 2 is opened;

FIG. 4 is a drawing showing a state after the front end of the printer in the state in FIG. 3 is enlarged;

FIG. 5 is a drawing showing a state after the peripheries of locking grooves at the front end of the printer in FIG. 4 are enlarged;

FIG. 6 is a solid diagram showing a state after a lower casel is demounted from the printer and the upper case and the front cover are opened;

FIG. 7 is a drawing showing a state after the front end of a printer main body in the state in FIG. 6 is enlarged;

FIG. 8 is a drawing showing a state that the end of a rotating shaft of a second guide roller equipped with a discharge guidance section is caught in the locking grooves of the printer main body in the state in FIG. 7;

FIG. 9 is a drawing showing a state after the discharge guidance section in the state in FIG. 8 is demounted;

FIG. 10 is an enlarged drawing of the locking grooves;

FIG. 11 is a drawing showing a state in the process of closing the front cover;

FIG. 12 is a drawing showing a state that the front cover is closed; and

FIG. 13 is an enlarged drawing of a peeling platen roller in the state in FIG. 12 and its periphery.

### DETAILED DESCRIPTION

According to one embodiment, a printer comprises a storing section configured to store a label paper attached with a label on backing paper in a peelable way, a printing section configured to print on the label, a peeling platen roller configured to be rotated by driving force from a driving unit acting through a driving gear and be butted with the backing paper to convey the backing paper, a peeling unit configured to peel the label from the backing paper conveyed by the peeling platen roller, a first guide roller configured to press the backing paper from a surface opposite to a surface butted with the peeling platen roller and butt the backing paper with the peeling platen roller and a second guide roller configured to press the backing paper by butting with the backing paper from the surface opposite to the surface butted with the peeling platen roller between the peeling unit and the peeling platen roller.

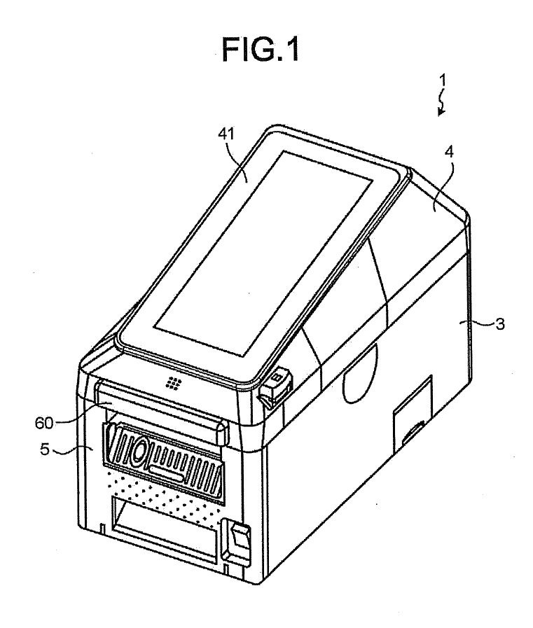

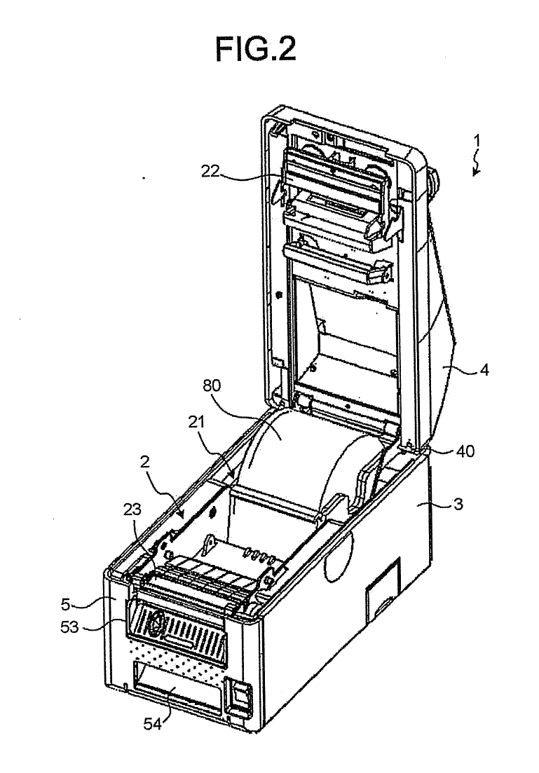

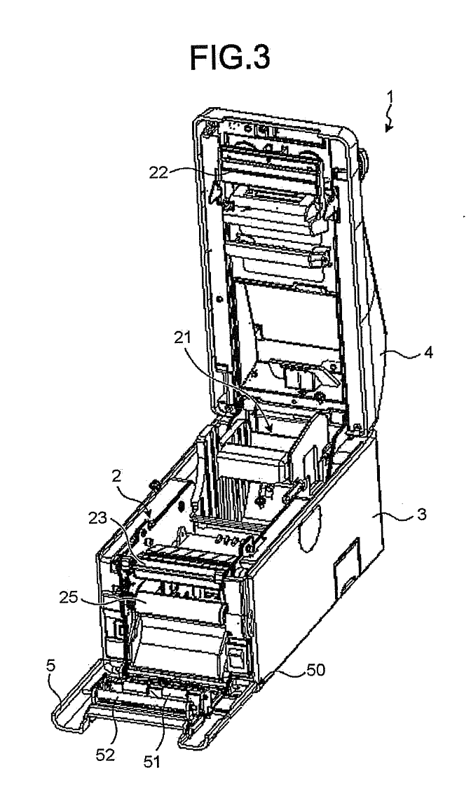

Hereinafter, the printer to which the present embodiment relates is described. FIG. 1 is a solid diagram showing the printer to which the embodiment relates; FIG. 2 is a solid diagram showing a state after an upper case of the printer shown in FIG. 1 is opened; and FIG. 3 is a solid diagram showing a state after a front cover of the printer in the state in FIG. 2 is opened.

As shown in FIG. 1 to FIG. 3, the printer 1 to which the present embodiment relates mainly comprises a printer main body 2, a lower case 3 storing the printer main body 2, the upper case 4 covering the upper part of the printer main body 2, which is supported on the printer main body 2 in a rotatable way by a first rotary supporting section 40, and the front cover 5 covering the front of the printer main body 2, which is supported on the printer main body 2 in the rotatable way by a second rotary supporting section 50. The printer main body 2 is stored in a space formed by the upper case 4, the lower case 3 and the front cover 5, so as to protect the printer main body 2 from the impact or dust and the like from an exterior.

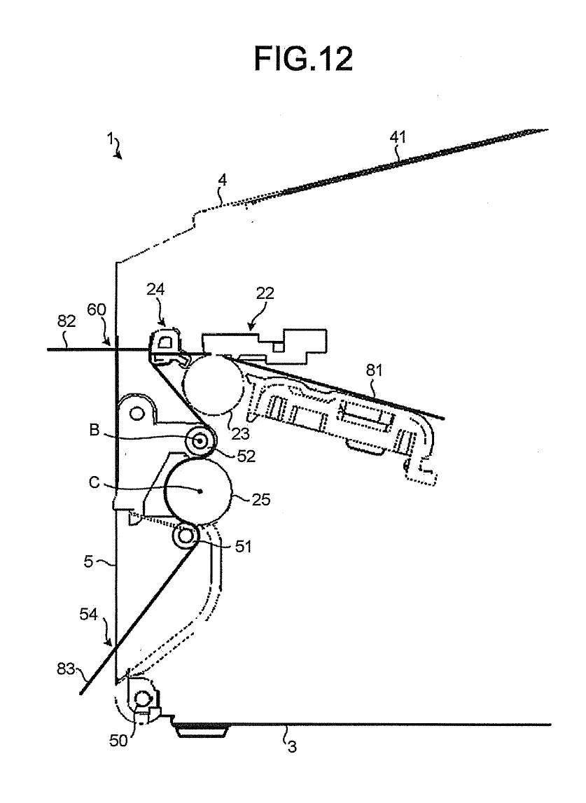

The interior of the printer main body 2, as described below, is provided with the backing paper, the storing section 21 storing the label paper 80 formed by the labels attached on the backing paper in the peelable way, a printing head 22 printing the label, a platen roller 23, a peeling plate 24 as the peeling unit, and the peeling platen roller 25 (referring to FIG. 12).

The lower case 3 is a rectangular solid case whose upper surface and front surface are open; the upper surface of the lower case 3 is closed by the upper case 4; and moreover, the front surface of the lower case 3 is closed by the front cover 5, so as to protect the printer main body 2 inside. The lower case 3 is internally provided with the printer main body 2 used for connecting the interior, a connection terminal of external equipment, which is not shown in figures, a power supply terminal which is used for supplying power to the printer main body 2 and is not shown in the figures, and the like.

The upper case 4 is used as an opening/closing component which can open the storing section 21 of the printer main body 2 by opening the opening/closing component. A display 41 as a touch panel is arranged in the upper case 4, and an operator can carry out various operations and confirm various messages by using the display 41.

The front cover 5 is internally provided with the first guide roller 51 and the second guide roller 52 which are used for peeling and conveying the backing paper 83 and synergistically act with the peeling platen roller 25, a discharge guidance section 53 guiding the discharge of the label 82, and a backing paper discharge port 54 discharging the backing paper 83 from which the label 82 is peeled. The front cover 5 covers the front of the printer main body 2 in an openable/closable way, and by the opening and the closing of the front cover 5, the peeling platen roller 25 arranged in the printer main body 2 is outwards opened or outwards enclosed.

The first guide roller 51 is arranged on the front cover 5 in the rotatable way by using an elastic component. In the state that the front cover 5 is closed, the first guide roller 51 presses the backing paper 83 from a downstream side where the conveyance direction of the backing paper 83 is observed from the peeling platen roller 25, so that the backing paper 83 is butted with the peeling platen roller 25 (referring to FIG. 12).

The second guide roller 52 is arranged on the front cover 5 in the rotatable way. In the state that the front cover 5 is closed, the second guide roller 52 is butted with the backing paper 83 from the side of the front cover 5 and carries out the pressing between the peeling plate 24 and the peeling platen roller 25 (referring to FIG. 12).

A specified interval is arranged between the upper end of the front cover 5 and the lower part of the front end of the upper case 4, and a label discharge port 60 discharging the printed label 82 is arranged in the interval.

The discharge guidance section 53 is a guidance component arranged near the upper end of the front cover 5 and enabling the label 82 discharged from the label discharge port 60 to be smoothly discharged towards the exterior of the printer 1. The discharge guidance section 53 is mounted on the front cover 5 in an angle-adjustable way through a rotating shaft of the second guide roller 52. In this way, the quantity of the components is reduced by mutualizing a rotating shaft of the discharge guidance section 53 and the rotating shaft of the second guide roller 52, so that the miniaturization and the low cost of an apparatus are realized.

The backing paper discharge port 54 is arranged at the lower part of the discharge guidance section 53 of the front cover 5, so that the backing paper 83 from which the label 82 is peeled is discharged from the backing paper discharge port 54.

Next, the internal structure of the printer main body 2 is described by using FIG. 1. to FIG. 3 and FIG. 12. FIG. 12 shows a state that the front cover 5 is closed.

The storing section 21 is in a storeer shape whose upper part is open. In the state that the upper case 4 is opened, the label paper 80 formed by being wound into a roller shape is inserted into and stored in the storing section 21 in a throwing-into way through an open part at the upper part of the storing section 21.

The platen roller 23 is rotated by a step motor (not shown in the figures and abbreviated as “motor” hereinafter) driven by the control of a control section (not shown in the figures) and the rotary force of the motor, which is transmitted by the driving gear (not shown in the figures), conveys the label paper 80, and moreover, presses the label 82 towards the printing head 22.

The printing head 22 carries out the printing on the label 82 positioned on a led-out section 81 led out from the label paper 80 by the rotation of the platen roller 23.

The peeling platen roller 25 is rotated by the rotary force of the motor (not shown in the figures) transmitted through the driving gear (not shown in the figures), so as to convey the backing paper 83 towards the backing paper discharge port 54.

The peeling plate 24 peels the label 82 from the backing paper 83 conveyed by the rotation of the peeling platen roller 25.

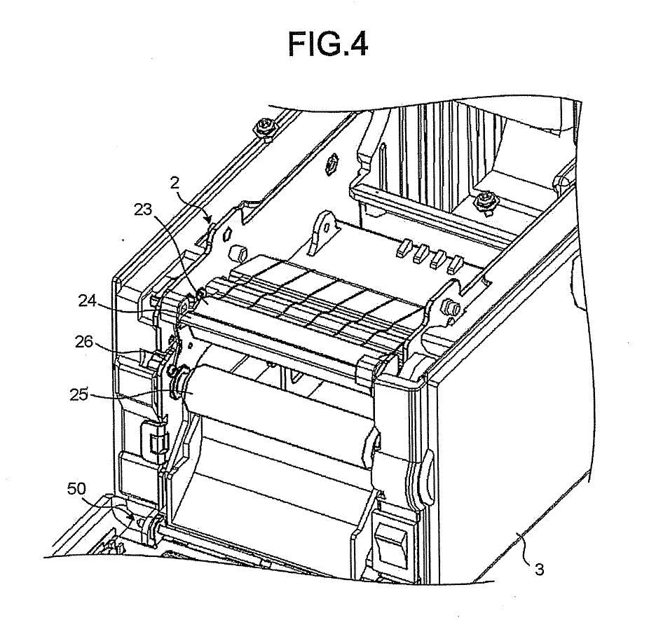

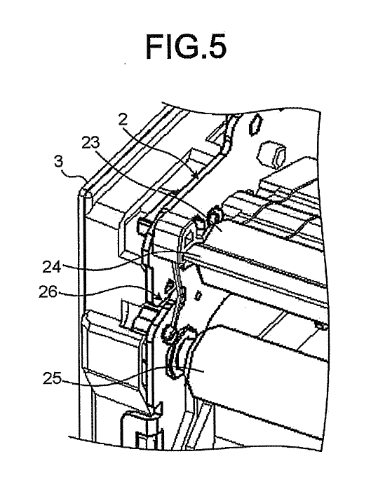

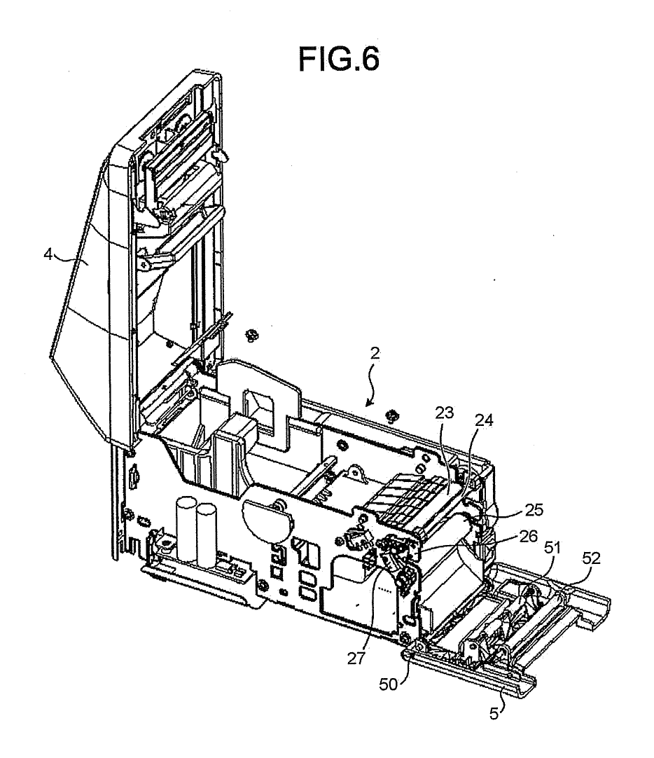

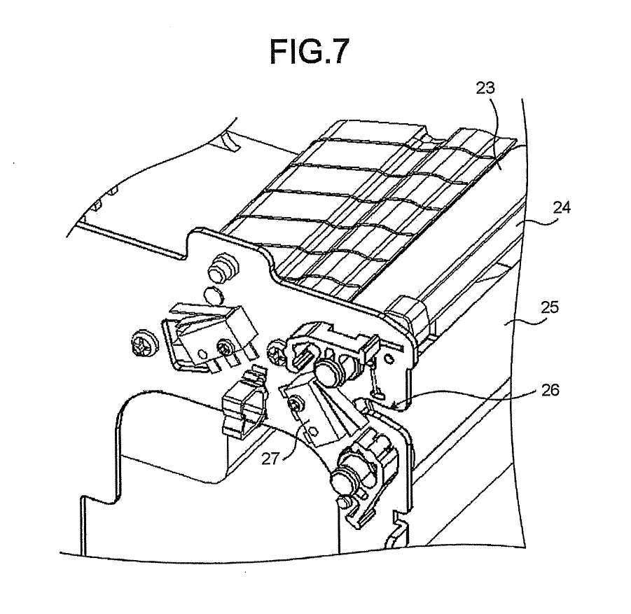

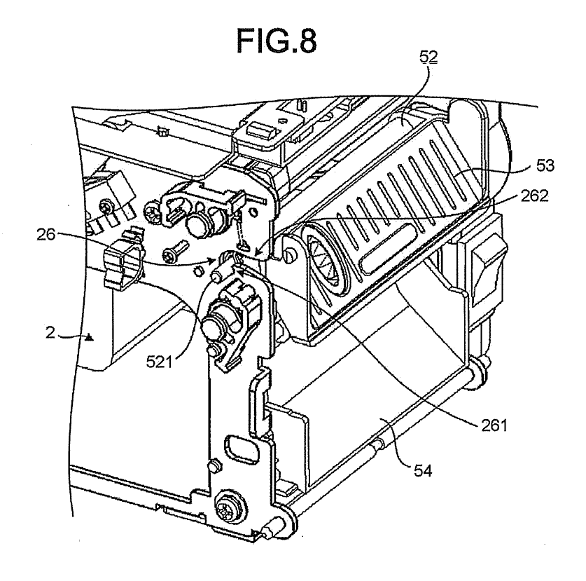

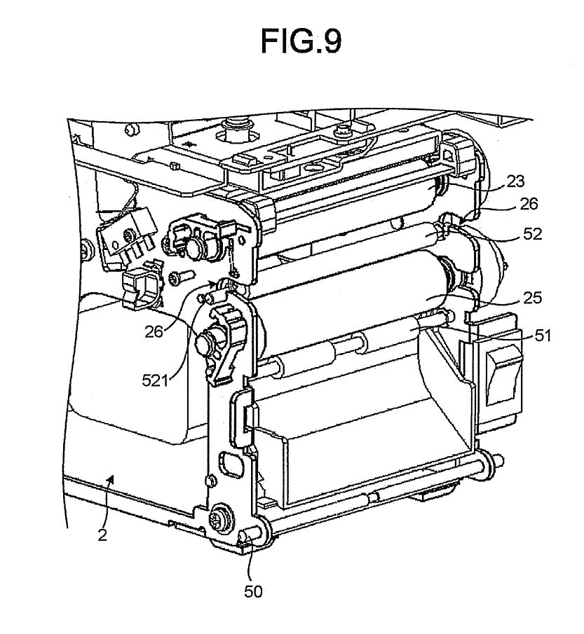

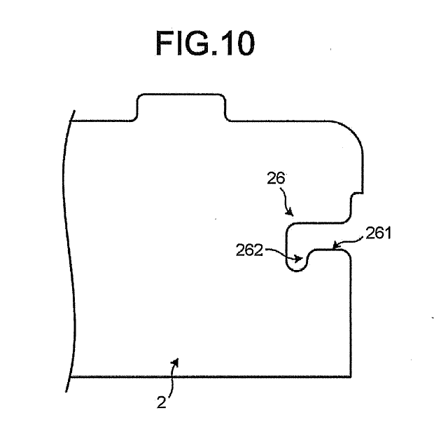

FIG. 4 is an enlarged drawing of the front end of the printer in the state in FIG. 3; FIG. 5 is an enlarged drawing of the peripheries of locking grooves at the front end of the printer in FIG. 4; FIG. 6 is a solid diagram showing a state after the lower case is removed from the printer and the upper case and the front cover are opened; FIG. 7 is an enlarged drawing of the front end of the printer main body in the state in FIG. 6; FIG. 8 is a drawing showing a state that the ends of the rotating shaft of the second guide roller equipped with the discharge guidance section are caught in the locking grooves of the printer main body in the state in FIG. 7; FIG. 9 is a drawing showing a state after the discharge guidance section is removed in the state in FIG. 8; and FIG. 10 is an enlarged drawing of the locking grooves.

As shown in FIG. 4 to FIG. 10, the outer wall of the printer main body 2 is provided with the locking grooves 26 locking the front cover 5 on the printer main body 2 by the embedment of the ends 521 of the rotating shaft of the second guide roller 52. The locking grooves 26 are in approximate L shapes whose internal peripheries have no corner angles and which are smoothly bent, and moreover, are respectively arranged on the front ends of the left side wall and the right side wall of the printer main body 2. The locking grooves 26 comprise horizontal sections 261 formed from the front end of the outer wall of the printer main body 2 along a horizontal direction and concave sections 262 formed by being continuously and smoothly bent downwards towards a vertical direction together with the horizontal sections 261. The horizontal sections 261 are arranged on the action paths of the ends 521 of the rotating shaft of the second guide roller 52 arranged on the front cover 5 when the front cover 5 is closed. The widths of the horizontal sections 261 and the concave sections 262 of the locking grooves 26 are all the sizes of the ends 521 of the rotating shaft of the second guide roller 52 caught in the horizontal sections and the concave sections.

In the printer main body 2, a microswitch 27 is arranged near the locking grooves 26, and the microswitch 27 is pressed by the ends 521 to be contacted between connection points when the ends 521 of the rotating shaft of the second guide roller 52 are caught in the locking grooves 26, so that the closure of the cover 5 is detected.

In the printer 1 to which the present embodiment relates, when the front cover 5 is closed, the peeling platen roller 25, the first guide roller 51 and the second guide roller 52 act synergistically, so that the backlash of a gear driving the peeling platen roller 25 can be acquired. This aspect is described in detail below.

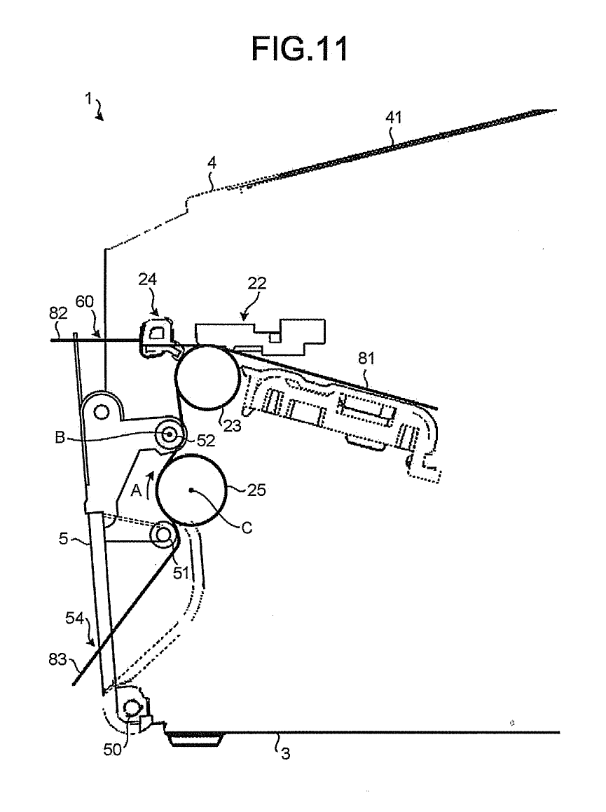

FIG. 11 shows a state in the process of closing the front cover 5, and FIG. 12 shows a state that the front cover 5 is closed.

As shown in FIG. 11, when the front cover 5 is closed, first, the first guide roller 51 is in a state of being butted with the backing paper 83 from which the label 82 is peeled. The backing paper 83 is in a state of being pressed towards the peeling platen roller 25 with specified pressing force by the first guide roller 51, so as to prevent the backing paper 83 from deviating from the peeling platen roller 25. In addition, the first guide roller 51 is arranged on the front cover 5 through the elastic component 56; therefore, even though the front cover 5 is further closed, only the elastic component 56 deforms; the relative position of the first guide roller 51 relative to the peeling platen roller 25 also cannot be changed; and therefore, the state that the first guide roller 51 is butted with the peeling platen roller 25 can be held.

As shown in FIG. 11, if the front cover 5 is further closed after the first guide roller 51 presses the backing paper 83 towards the peeling platen roller 25, the second guide roller 52 is butted with the backing paper 83 at a position between the peeling plate 24 and the peeling platen roller 25. At the moment, by pressing the backing paper 83 by utilizing the pressing force of the second guide roller 52, traction force is applied to the peeling platen roller 25 through the packing paper 83. The traction force plays a role in rotating the peeling platen roller 25 towards a direction (called as “opposite direction” hereinafter) A opposite to a rotation direction when the backing paper 83 is conveyed usually. Afterwards, as the backing paper 83 is difficult to deviate from the peeling platen roller 25 under the action of the pressing force of the first guide roller 51, the traction force is effectively transmitted to the peeling platen roller 25.

As shown in FIG. 12, if the front cover 5 is closed completely, the pressing force with which the first guide roller 51 presses the backing paper 83 towards the peeling platen roller 25 is stronger, so that the backing paper 83 is more difficult to deviate from the peeling platen roller 25. In addition, if the front cover 5 is closed completely, the second guide roller 52 is further pressed in the printer main body 2, so that the traction force is further applied towards the peeling platen roller 25 from the backing paper 83, and the peeling platen roller 25 is further rotated towards the opposite direction from the state in FIG. 11.

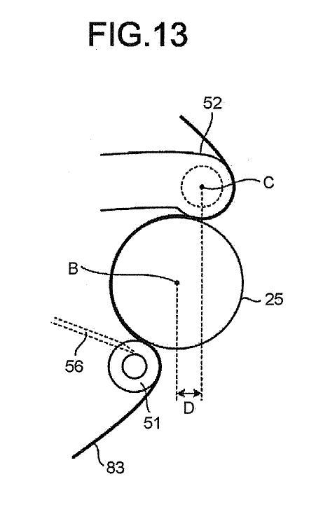

FIG. 13 is an enlarged drawing of the peeling platen roller in the state in FIG. 12 and its periphery. As shown in FIG. 12 and FIG. 13, in the state that the front cover 5 is closed completely, the rotating shaft C of the second guide roller 52 is further pressed towards an inner side and deviates towards the inside of the printer main body 2 for a distance D more than the rotating shaft B of the peeling platen roller 25, and therefore, the traction force caused by the pressing force of the second guide roller 25 and enabling the peeling platen roller 25 for the backing paper 83 to rotate towards the opposite direction becomes stronger traction force.

In this way, the traction force is applied to the peeling platen roller 25 through the backing paper 83 pressed by the second guide roller 52 to rotate the peeling platen roller 25 towards the opposite direction, so that the gear rotating the peeling platen roller 25 also rotates towards the direction opposite to the rotation direction when the backing paper is conveyed usually. Thus, the gear is in an engagement state, and therefore, the backlash of the gear can be eliminated when the printer 1 is in an idling state. Moreover, as the backlash of the gear disappears, the idling of the gear can be prevented when the printer 1 is started up subsequently to begin printing the label 82. That is, by properly rotating the peeling platen roller 25, the conveyance of the label 82 is executed normally, so that the printing can be effectively prevented from generating gap or shrinkage.

By pressing the backing paper 83 through the second guide roller 52, the contact area of the peeling platen roller 25 and the backing paper 83 is increased; friction force acting between the peeling platen roller 25 and the backing paper 83 is increased; therefore, the slippage of the backing paper 83 can be prevented; and moreover, the conveyance of the backing paper 83 can be effectively carried out.

If the front cover 5 is closed, the ends 521 of the rotating shaft of the first guide roller 51 enter the locking grooves 26 arranged on the side walls of the printer main body 2 along the horizontal direction. The situation at the moment is described by using FIG. 10.

The ends 521 of the rotating shaft of the first guide roller 51 first enter the horizontal sections 261 of the locking grooves 26. Next, if the ends 521 further enter the locking grooves 26, a marching direction is changed along with the smooth bending of the locking grooves 26, so that the ends enter the concave sections 262 continuously formed downwards towards the vertical direction from the horizontal sections 261. As the two ends 521 of the rotating shaft are caught in the concave sections 262, and moreover, actions towards the horizontal direction are limited, the action of the front cover 5 towards the horizontal direction, namely the opening/closing action of the front cover 5, is in a locked state. In addition, the locking can be relieved by lifting the two ends 521 of the rotating shaft of the first guide roller 51 to enable the ends 521 to move towards the horizontal sections 261 from the concave sections 262 along with the smooth bending of the locking grooves 26.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, the first guide roller 51 and the second guide roller 52 also can be arranged on the side of the printer main body 2, and moreover, the peeling platen roller 25 is arranged on the side of the front cover 5. Under the circumstances, if the front cover 5 is further closed after the first guide roller 51 presses the backing paper 83 towards the peeling platen roller 25, the second guide roller 52 also can be butted with the backing paper 83 at the position between the peeling plate 24 and the peeling platen roller 25.

Under the circumstances, by pressing the backing paper 83 through the pressing force of the second guide roller 52, the traction force is applied to the peeling platen roller 25 through the backing paper 83. The traction force plays a role in rotating the peeling platen roller 25 towards the opposite direction A. Moreover, as the backing paper 83 is difficult to deviate from the peeling platen roller 25 under the action of the pressing force of the first guide roller 51, the traction force is effectively transmitted to the peeling platen roller 25.

In this way, the traction force is applied to the peeling platen roller 25 through the backing paper 83 pressed in by the second guide roller 52 to rotate the peeling platen roller 25 towards the opposite direction, so that the gear rotating the peeling platen roller 25 also rotates towards the direction opposite to the rotation direction when the backing paper is conveyed usually. Thus, the gear is in the engagement state, and therefore, the backlash of the gear can be eliminated when the printer 1 is in the idling state. Moreover, as the backlash of the gear disappears, the idling of the gear can be prevented when the printer 1 is started up subsequently to begin printing the label 82. That is, by properly rotating the peeling platen roller 25, the conveyance of the label 82 is executed normally, so that the printing can be effectively prevented from generating the gap or the shrinkage.

What is claimed is:

1. A printer, comprising:
a storing section configured to store a label paper attached with a label on backing paper in a peelable way;
a printing section configured to print on the label;
a peeling platen roller configured to be rotated by driving force from a driving unit acting through a driving gear and be butted with the backing paper to convey the backing paper;
a peeling unit configured to peel the label from the backing paper conveyed by the peeling platen roller;
a first guide roller configured to press the backing paper from a surface opposite to a surface butted with the peeling platen roller and butt the backing paper with the peeling platen roller; and
a second guide roller configured to press the backing paper by butting with the backing paper from the surface opposite to the surface butted with the peeling platen roller between the peeling unit and the peeling platen roller.

2. The printer according to claim 1, wherein
a rotating shaft of the second guide roller is positioned at a position approaching an inner side more than a rotating shaft of the peeling platen roller as seen from a side where the second guide roller is butted with the backing paper.

3. The printer according to claim 1, wherein
the first guide roller is supported through an elastic component.

4. The printer according to claim 1, further comprising:
a locking grooves, that the rotating shaft of the second guide roller is caught in the locking grooves, so as to hold a state that the second guide roller is butted with the backing paper.

5. The printer according to claim 4, wherein
the locking grooves includes a horizontal section formed along a horizontal direction and a concave section formed in the horizontal section by being continuously bent downwards towards a vertical direction.

6. The printer according to claim 1, further comprising:
a discharge port configured to discharge the label which is printed and peeled from the backing paper; and
a discharge guidance section configured to guide the discharge of the label from the discharge port, wherein
the discharge guidance section is mounted in a rotatable way through a shaft common with the rotating shaft of the second guide roller.
